(19) United States
(12) Patent Application Publication
(10) Pub. No.: US 2015/0077337 A1
(43) Pub. Date: Mar. 19, 2015

(54) SYSTEM AND METHOD FOR INTERACTIVE VISUALIZATION OF INFORMATION IN AN AIRCRAFT CABIN

(71) Applicant: Airbus Operations GmbH, Hamburg (DE)

(72) Inventors: Gerald COTO-LOPEZ, Hamburg (DE); Johannes HERTEL, Hamburg (DE); Sven KNEFELKAMP, Hamburg (DE)

(21) Appl. No.: 14/489,712

(22) Filed: Sep. 18, 2014

(30) Foreign Application Priority Data
Sep. 19, 2013 (EP) 13 185 220.4

(51) Int. Cl. B64D 11/00; G06F 3/01; B64D 47/08

(52) U.S. Cl. CPC B64D 11/0015; B64D 47/08; G06F 3/017
USPC 345/156

(57) ABSTRACT

An interactive aircraft cabin window display system and a method for interactive visualization of information in an aircraft cabin are described. The display system includes a display assembly DA integratable into an aircraft cabin window, a passenger monitoring assembly PMA, an environment monitoring assembly EMA, and an information visualization assembly IVA. The DA is adapted for displaying variable images on a screen such as a semi-transparent screen integrated in the aircraft cabin window. The PMA may be implemented using for example an eye-tracking camera or a touch-screen and is adapted for detecting a direction into which a passenger is looking or pointing through the aircraft cabin window. The EMA is adapted for acquiring a representation such as an image of an environment outside the aircraft cabin window. The WA is adapted for visualizing information on the screen at specific locations selected by taking into account the representation acquired by the EMA and taking into account the direction detected by the PMA. Accordingly, the interactive display system may detect to which object a passenger is currently looking or pointing and may interactively provide additional information about this object of interest, thereby improving the passenger's flight experience.

### CROSS REFERENCE TO RELATED APPLICATIONS

This application claims priority to European Patent Application No. EP 13 185 220.4, filed Sep. 19, 2013, which is incorporated herein by reference in its entirety.

### TECHNICAL FIELD

This application pertains to a system and a method for interactive visualization of information in an aircraft cabin. Furthermore, the application relates to a computer program product adapted for controlling such a method and a computer readable medium comprising such computer program product stored thereon.

### BACKGROUND

In modern passenger aircraft, entertainment systems are provided for entertaining and informing passengers during long flights. For example, large displays are arranged on top of several passenger seats in order to show entertainment programs to a plurality of passengers. Alternatively, each passenger may be provided with his or her own display arranged for example on a rear side of each passenger seat. On such displays, it is common to provide current information about the flight, such as flight position, distance to the airport, flight height, outside temperature, etc. Furthermore, other visual contents such as entertaining movies, advertisements, or information from the flight crew to the passenger may be displayed.

As an alternative to providing separate displays in front or on top of passenger seats, it has been proposed to include an information and entertaining system with displays for example in cabin windows of an aircraft. Such approach is described for example in DE 10 2006 007 284 A1 and US 2010 005 495 A1.

There is a need for improved systems and methods for providing information to a passenger in an aircraft cabin, such that the passenger may easily and intuitively request information of interest to the passenger. In addition, other objects, desirable features, and characteristics will become apparent from the subsequent summary and detailed description, and the appended claims, taken in conjunction with the accompanying drawings and this background.

### SUMMARY

According to one embodiment of the present disclosure, an interactive aircraft cabin window display system includes a display assembly, a passenger monitoring assembly, an environment monitoring assembly and an information visualisation assembly. The display assembly may be integrated into an aircraft cabin window. Furthermore, the display assembly is adapted for displaying variable images on a screen integrated into the aircraft cabin window. The passenger monitoring assembly is adapted for detecting a direction in which a passenger is looking or pointing through the aircraft cabin window. The environment monitoring assembly is adapted for acquiring a representation of an environment outside the aircraft cabin window. The information visualization assembly is adapted for visualizing information on the screen of the display assembly at specific locations wherein these locations are specifically selected by taking into account the representation acquired by the environment monitoring assembly and taking into account the direction detected by the passenger monitoring assembly.

According to a second embodiment of the present disclosure, a method for interactive visualization of information in an aircraft is provided. The method comprises the steps of detecting a direction in which a passenger is looking or pointing through an aircraft cabin window using a passenger monitoring assembly, acquiring a representation of an environment outside the aircraft cabin window using an environment monitoring assembly, and visualizing information on a screen integrated into the aircraft cabin window at specific locations selected by taking into account the representation acquired by the environment monitoring assembly and taking into account the direction detected by the passenger monitoring assembly.

Further embodiments of the present disclosure are directed to a computer program product comprising computer readable instructions for instructing a computer to perform the above mentioned method, and a computer readable medium comprising such computer program product stored thereon.

Conventional in-flight entertainment (IFE) systems mainly serve for entertaining passengers during flights by displaying movies, playing music or enabling playing computer games. A main purpose of all these entertainment options is to distract the passenger from the actual flight. At most, some basic information concerning the flight is provided, mainly in the form of numbers concerning data such as flight distance, flight height, outside temperature, and the like.

However, while in the early days of flight passengers were fascinated by the fact that they were travelling through the air and were able to observe the earth through the cabin windows from a bird's perspective, today's passengers are typically very distracted from such actual flight experiences and, instead, are invited by the IFE to enjoy entertainment that is typically not related to any flight experience.

Aspects and embodiments of the present disclosure aim at enabling provision of information to a flight passenger in a specific manner, such as to improve the passenger's flight experience.

For this purpose, an interactive display system is provided wherein a display assembly may be integrated into an aircraft cabin window, i.e., at a position where the passenger used to look outside the aircraft in order to observe an environment. The display assembly may be adapted such that various image contents may be displayed within the aircraft cabin window.

Furthermore, the interactive display system comprises a passenger monitoring assembly and an environment monitoring assembly. The passenger monitoring assembly may detect a direction in which a passenger is currently looking through the aircraft cabin window. Alternatively, the passenger monitoring assembly may detect a direction in which a passenger is currently pointing through the aircraft cabin window using for example one of his fingers. The environment monitoring assembly may acquire a visual representation such as an image or a video stream of an environment outside the aircraft cabin window.

An information visualization assembly comprised by the interactive display system may then analyse data provided by the passenger monitoring assembly and by the environment monitoring assembly in order to detect, for example, an object in the aircraft's environment that the passenger is currently looking or pointing at, and to then, for example, provide information about that object.

Accordingly, a passenger may demand information about things or objects he sees through the aircraft cabin window in a very easy, intuitive, and interactive manner. Thereby, the passenger's flight experience may be significantly improved.

According to an embodiment, the passenger monitoring assembly may be adapted for tracking a direction in which eyes of the passenger are directed.

In other words, using the passenger monitoring assembly, the interactive display system may analyze in which direction a passenger is currently looking through the aircraft window. Based on such information, the interactive display system may determine which object the passenger is currently observing through the cabin window and may then provide, for example, additional information about this object. Such eye-tracking enables very intuitive information provision to the passenger.

In this context, the term “direction” may include one or preferably both of an orientation into which the passenger's eyes are currently looking and a position of the passenger's head and specifically the passenger's eyes with respect to the aircraft cabin window through which he is currently looking.

According to an embodiment, the screen of the display assembly comprises a pressure sensitive matrix layer providing 2D information about a location pressed by a passenger and the passenger monitoring assembly is connected to the screen for receiving information from the pressure sensitive matrix layer.

In other words, the display assembly may be provided with a touch screen which may provide data signals indicating where a passenger has actually touched the screen, e.g., by pressing a position on the screen with one of his fingers. Using such touch screen, a passenger may point to a location within the aircraft cabin window at which he sees a specific object of interest and may thus intuitively demand further information about this object.

According to an embodiment, the screen comprised by the display assembly may be adapted such to enable switching to a transparent mode.

Such a screen may be implemented, on the one hand, to visualize information within the aircraft cabin window and, on the other hand, to provide at least a certain degree of transparency such that the passenger may still look through the aircraft cabin window and see the environment of the aircraft. For example, such screen may be provided using an LCD (liquid crystal display) having at least partially transparent electrodes and front and rear covers. Alternatively, semi-transparent OLED (organic light emitting diode) displays may be integrated into cabin windows.

According to an embodiment, the environment monitoring assembly may comprise at least one camera. Such camera may be attached to the aircraft and may be installed such as to be directed towards an outside environment of the aircraft. Preferably, two cameras are provided wherein each of the cameras may monitor one lateral side of the aircraft. The camera may be adapted to acquire, e.g., two-dimensional images or image sequences giving a representation of the environment outside the aircraft cabin window. Such images may be acquired at certain time intervals. For example, several images may be acquired per second, similarly to acquiring a movie. For example, the camera may include a photo detector such as a CCD (charge coupled device).

According to an embodiment, the proposed interactive aircraft cabin window display system may further comprise an output assembly adapted for outputting information to an external passenger end device (PED), such outputted information being provided by the information visualization assembly.

The output assembly may enable transmitting information from the information visualization assembly to an external passenger end device. Such passenger end device may be, for example, a mobile phone, a tablet computer, a laptop, etc. having preferably its own display and integrated memory for storing information, specifically visually displayable information.

Accordingly, using the display system's output assembly, a passenger may easily demand information about an object of interest outside the aircraft window and may then output such information to his own PED. Additionally, for example, further information such as an image provided by a camera included in the environment monitoring assembly may be transmitted to the PED, thereby enabling for example an easy way of taking pictures of an aircraft's environment using the passenger's end device.

The output assembly may be adapted for outputting information via wireless data transmission. Such wireless data transmission may be implemented using, e.g., WiFi, Bluetooth, or near-field-communication (NFC). Such wireless data transmission further improves easy and intuitive use of the proposed interactive display system.

According to a further embodiment, the display system is further adapted for receiving and displaying data from an in-flight entertainment system.

In one embodiment, the display assembly of the interactive display system may be used as an additional display in the aircraft cabin to be easily observed, for example, by a passenger sitting on a window seat such that conventional information contents such as movies may be displayed.

In addition to such conventional displaying options, interactive displaying options may be enabled using, for example, the passenger monitoring assembly for detecting a position at which a passenger is currently looking or pointing on a screen of the display assembly. Using such an option for easy and intuitive interactivity, a passenger may for example control the in-flight entertainment system and may, e.g., select information content provided by such IFE system or such option for interactivity may be used in playing computer games provided by the IFE system.

The proposed interactive aircraft cabin window display system may be installed in an aircraft.

Such aircraft may comprise, for example, a plurality of display assemblies, each being integrated into one of a plurality of aircraft cabin windows. The aircraft may further comprise a plurality of passenger monitoring assemblies, each being installed in an aircraft cabin such as to monitor actions of a passenger sitting next to one of the plurality of aircraft cabin windows. Finally, the aircraft may comprise at least two environment monitoring assemblies, wherein each one of these environment monitoring assemblies is installed such as to acquire a representation of an environment of the aircraft at one of both sides of the aircraft.

It is noted that possible features and advantages of embodiments of the present disclosure are described herein with respect to an inventive interactive aircraft cabin window display system, an aircraft comprising such system, a method for interactive visualization of information in an aircraft, and a computer program product or a computer readable medium. One skilled in the art will understand that the features may be suitably combined or replaced or transferred to other embodiments in an analogue manner thereby creating further embodiments.

### BRIEF DESCRIPTION OF THE DRAWINGS

The various embodiments will hereinafter be described in conjunction with the following drawing figures, wherein like numerals denote like elements, and:

.

FIG. 1 shows an example of an interactive aircraft cabin window display system.

FIG. 2 shows an example of an aircraft comprising an interactive aircraft cabin window display system.

FIG. 3 shows an example of a display assembly and an output assembly of an interactive aircraft cabin window display system.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

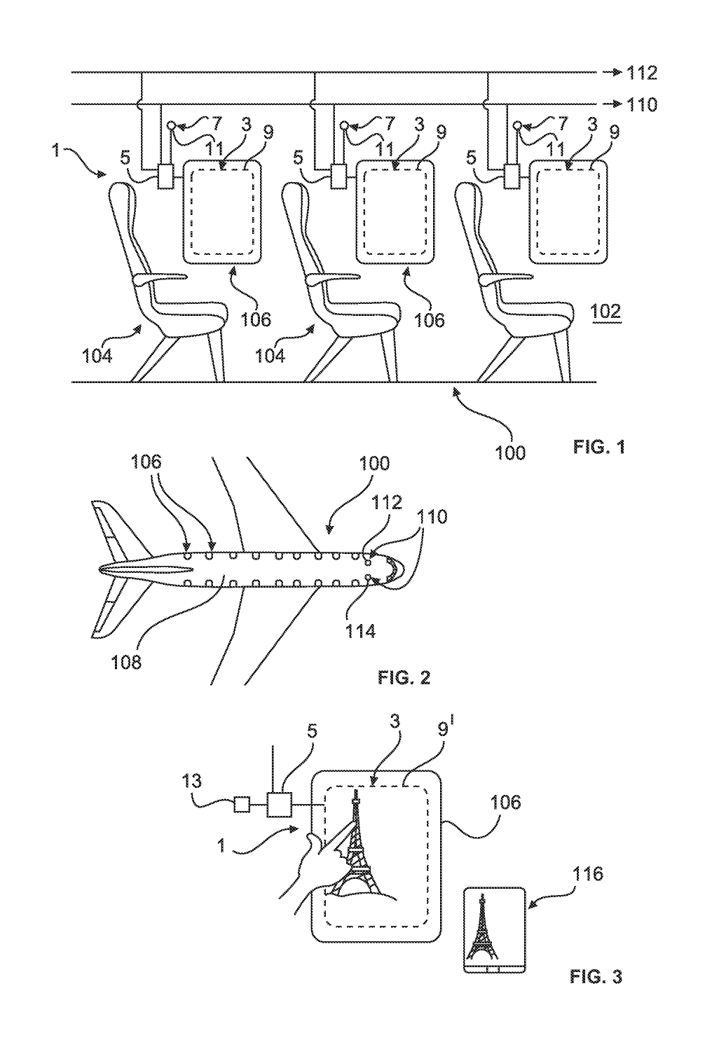

FIG. 1 shows a portion of a cabin 102 in an interior of an aircraft 100. FIG. 2 shows a top view onto the aircraft 100.

In the cabin 102, several rows of seats 104 are arranged one behind the other. Each seat 104 is arranged next to an aircraft cabin window 106 provided in a fuselage 108 of the aircraft 100.

In the aircraft cabin 102 an interactive aircraft cabin window display system 1 according to an embodiment of the present disclosure is provided. The display system 1 comprises a plurality of display assemblies 3. Each display assembly 3 is arranged in one of the cabin windows 106. Each display assembly 3 is connected to and controlled by an information visualization assembly 5. Each information visualization assembly 5 is connected to a passenger monitoring assembly 7 positioned in the interior of the cabin 102 and to one of two environment monitoring assemblies 110 arranged at an outside of the fuselage 108 of the aircraft 100.

The display assemblies 3 comprise a screen 9 integrated into the aircraft cabin window 106. The screen 9 typically comprises a multiplicity of pixels arranged in a two-dimensional matrix, wherein each of the pixels may be controlled to provide a certain degree of transparency and/or colour. By suitably controlling the multiplicity of pixels, variable images may be displayed by the display assembly 3. Accordingly, the display assembly 3 integrated into the cabin windows 106 will enable a visualization of digital pictures in the cabin windows 106. For areas of the display assembly not showing any portion of a picture, the cabin window 106 including the display assembly 3 may be transparent as is normally the case. Accordingly, the screen 9 of the display assembly 3 may be provided as a semi-transparent screen such that displayed pictures may have adjustable levels of transparency and brightness. For example, head-up display projection technology, new semi-transparent LCD display technology, or other technologies may be used for implementing the display assembly 3.

Each of the display assemblies 3 may be controlled by an associated information visualization assembly 5 to display various types of information or entertainment. For example, each information visualization assembly 5 may be connected to two different data streams of a cabin distribution network 112 of an in-flight entertainment system or any other available data bus. The two data streams may reflect a left-hand and right-hand row of cabin windows 106 on the aircraft cabin 102, respectively. A connected IFE server may generate at least two separate data streams, i.e., one for each side of the aircraft. Images generated in the servers may make use of aircraft information generated for example by aircraft avionic systems and from information available from ground-based servers. More streams may be generated depending on a number of different views to be simultaneously displayed.

In order to provide intuitive interactivity for the display system 1, each portion of the display system 1 adjacent to one of the seats 104 and one of the cabin windows 106 is provided with a passenger monitoring assembly 7. The passenger monitoring assembly 7 is adapted for detecting a direction in which a passenger sitting, for example, on the window seat 104, is looking through the aircraft cabin window 106 or pointing through the aircraft cabin window 106.

In the embodiment shown in FIG. 1, the passenger monitoring assembly 7 is provided as an eye-tracking system adapted for tracking a direction in which eyes of a passenger are directed. For such purpose, a small camera 11 is provided within the aircraft cabin 102 at a location close to an upper part of the window seat 104 such that its optics are directed to a region that typically coincides with a head of a passenger sitting on the window seat 104. Using such camera 11 together with a suitable control algorithm, the passenger monitoring assembly 7 may detect the eyes of the passenger and their orientation, and from such information the passenger monitoring assembly 7 may derive a direction into which the passenger is currently looking. Such information from the eye-tracking passenger monitoring assembly 7 may then be transmitted to the information visualization assembly 5.

Furthermore, in one embodiment, the information visualization assembly 5 is connected to an environment monitoring assembly 110. The environment monitoring assembly 110 may comprise two cameras 112, 114 arranged at an outer skin of the fuselage 108 of the aircraft 100. Each camera 112, 114 may acquire an image representing an environment at one of both sides of the aircraft 100. Such image information may then be transmitted to each of the information visualization assemblies 5.

Based on the information of both the passenger monitoring assembly 7 and the environment monitoring assembly 110, the information visualization assembly 5 may control the display assembly 3 to, for example, visualize suitable information on the screen 9 at specific locations. Therein, the information visualization assembly 5 may, for example, analyse a direction in which the passenger is currently looking through the window 106 and may then determine, using the representation information acquired from the environment monitoring assembly 112, at which object outside the aircraft 100 the passenger is probably currently looking. Having identified such object, the information visualization assembly 5 may acquire further information about this object, for example, from the IFE server. Finally, such additional information may then be displayed on the screen 9 at a suitable position such that the passenger is provided with the additional information about the object he is currently observing in an intuitive manner. For example, the information may be displayed at a position in close proximity to a location where the passenger sees the interesting object through the cabin window. Additionally, arrows may point to or lines may connect the information with such location.

In an alternative embodiment as shown in FIG. 3, the display assembly 3 is provided with a touch-screen 9′. Such touch-screen 9′ comprises a pressure sensitive matrix layer providing two-dimensional information on a location touched or pressed by a passenger. For example, such two-dimensional information may be acquired using information about an electrical capacity of the matrix layer wherein such capacity changes in dependence of a location pressed or touched by the passenger. Accordingly, the passenger monitoring assembly 7 connected to such a touch-screen may receive information from the pressure sensitive matrix layer included therein, and from such information the passenger monitoring assembly 7 may derive a direction that the passenger is currently pointing through the aircraft cabin window 106.

Furthermore, as shown in FIG. 3, the interactive aircraft cabin window display system 1 may comprise an output assembly 13 such as a WiFi transmitter, a Bluetooth transmitter, or an NFC transmitter. This output assembly 13 is connected to the information visualization assembly 5 and may wirelessly transmit data acquired by this information visualization assembly 5, for example, to an external passenger end device 116. The passenger end device 116 may be, for example, a passenger's mobile phone, notepad, or notebook.

Accordingly, using the proposed interactive aircraft cabin window display system 1, the passenger may, for example, observe an object of interest with his eyes or point at an object of interest with his finger on touch-screen 9′ of the passenger monitoring assembly 3. Then, using the information provided by the passenger monitoring assembly 7 together with the information provided by the environment monitoring assembly 110, the information visualization assembly 5 may not only show information about the object of interest on the screen 9′, but may also transmit an image of the outside environment including the object of interest together with additional information about this object of interest to the passenger end device 116.

Various methods for using the proposed interactive aircraft cabin window display system in an aircraft will be now presented.

In one embodiment, the proposed display system 1 may visualize a ground portion and a sky portion separated by an artificial horizon.

In one embodiment, aircraft performance parameters such as altitude, speed, direction, wind speed, etc. may be displayed.

In one embodiment, a moving map display may be overlaid on the ground portion of an image representation provided by the environment monitoring assembly. Additionally, points of interest may be displayed by overlaying specific markers onto the ground portion of the representation image of the environment.

In all such various types of displayed features, the interactive display system 1 may use its passenger monitoring assembly 7 in order to detect which objects are of particular interest for the passenger and may then provide additional information about these objects of interest.

For example, if an aircraft flies over Paris and a passenger observes the Eiffel tower longer than, for example, a specific time period or points with his finger to the Eiffel tower, the information visualization assembly 5 recognizes that the passenger is specifically interested in this city or specifically in this monument and may provide additional information about the city, such as its population, weather, temperature, sites to be seen, etc., or specific information about the Eiffel tower such as its height, age, architect, etc.

With respect to a sky portion of an environment representation image displayed in the display assembly, the interactive display system 1 may recognize when a passenger is observing or pointing to a neighbouring aircraft and may provide for example further information such as a flight number, start time, destination, altitude, speed, etc.

At night time, an overlay of star constellations and planets or even visible satellites may be displayed by the display assembly and upon detecting specific interest of the passenger, names of stars, planets or constellations and further information about these objects may be displayed.

In another embodiment, fixed or moving images may be displayed on the display assembly 3 as a type of “screen saver” for example for passenger marketing of entertainment. For example, airline logos or moving fish in an aquarium may be displayed.

Furthermore, in order to darken the cabin window 106 to a certain degree, the display assembly 3 and its screen 9 may be controlled to display a complete dark static image in order to thereby provide a level of window shading.

All views and visualizations generated by the proposed interactive display system 1 may be customizable by an airline or may be selected by an automatic flight script, a cabin purser via an IFE control panel, or by a passenger via the IFE system.

Summarizing, embodiments of the proposed interactive aircraft cabin window display system 1 may allow for improved intuitive information provision to an aircraft passenger and may thereby improve the passenger's flight experience.

Finally, it shall be noted that terms such as “comprising”, “including” or similar do not exclude further elements or steps and that the article “a” or “an” does not exclude the presence of plurality of objects. Reference signs in the claims shall not restrict the scope of the embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. An interactive aircraft cabin window display system, comprising:
a display assembly integratable into an aircraft cabin window;
a passenger monitoring assembly;
an environment monitoring assembly; and
an information visualization assembly;
wherein the display assembly is adapted to display variable images on a screen integrated in the aircraft cabin window;
wherein the passenger monitoring assembly is adapted to detect a direction in which a passenger is one of looking and pointing through the aircraft cabin window;
wherein the environment monitoring assembly is adapted to detect a representation of an environment outside the aircraft cabin window; and
wherein the information visualization assembly is adapted to visualize information on the screen at specific locations selected based on the representation acquired by the environment monitoring assembly and the direction detected by the passenger monitoring assembly.

2. The system according to claim 1, wherein the information visualization assembly is adapted to visualize information on the screen with respect to objects to which the passenger is one of looking and pointing, respectively.

3. The system according to claim 1, wherein the passenger monitoring assembly is adapted to track a direction in which the eyes of the passenger are directed.

4. The system according to claim 1, wherein the screen comprises a pressure sensitive matrix layer providing 2D information on a location pressed by the passenger and wherein the passenger monitoring assembly is connected to the screen for receiving information from the pressure sensitive matrix layer.

5. The system according to claim 1, wherein the screen may be switched to a transparent mode.

6. The system according to claim 1, wherein the environment monitoring assembly comprises at least one camera.

7. The system according to claim 1, further comprising an output assembly adapted for outputting information provided by the information visualization assembly to an external passenger end device.

8. The system according to claim 7, wherein the output assembly is adapted to output information via at least one of WiFi, Bluetooth and Near-Field-Communication.

9. The system according to claim 1, wherein the system is further adapted to receive and display data from an in-flight entertainment system.

10. An aircraft comprising:
a plurality of aircraft cabin windows;
a display assembly integratable into one of the plurality of aircraft cabin windows and comprising:
a passenger monitoring assembly;
an environment monitoring assembly; and
an information visualization assembly;
wherein the display assembly is adapted to display variable images on a screen integrated in the aircraft cabin window;
wherein the passenger monitoring assembly is adapted to detect a direction in which a passenger is one of looking and pointing through the aircraft cabin window;
wherein the environment monitoring assembly is adapted to detect a representation of an environment outside the aircraft cabin window; and
wherein the information visualization assembly is adapted to visualize information on the screen at specific locations selected based on the representation acquired by the environment monitoring assembly and the direction detected by the passenger monitoring assembly.

11. The aircraft according to claim 10, comprising
a plurality of the display assemblies, each being integrated into one of the plurality of aircraft cabin windows;
a plurality of passenger monitoring assemblies, each being installed in an aircraft cabin such as to monitor actions of a passenger sitting next to one of the plurality of aircraft cabin windows; and
two environment monitoring assemblies, each one environment monitoring assembly being installed such as to acquire a representation of an environment at one of both sides of the aircraft.

12. A method for interactive visualization of information in an aircraft cabin, the method comprising the steps of:
detecting a direction in which a passenger is one of looking and pointing through an aircraft cabin window of the aircraft cabin using a passenger monitoring assembly;
acquiring a representation of an environment outside the aircraft cabin window using an environment monitoring assembly; and
visualizing information on a screen integrated into the aircraft cabin window at specific locations selected based on the representation acquired by the environment monitoring assembly and the direction detected by the passenger monitoring assembly.

13. (canceled)

14. A non-transitory computer-readable medium including software instructions configured to cause a computing device to:
detect a direction in which a passenger is one of looking and pointing through an aircraft cabin window of an aircraft cabin using a passenger monitoring assembly;
acquire a representation of an environment outside the aircraft cabin window using an environment monitoring assembly; and
visualize information on a screen integrated into the aircraft cabin window at specific locations selected based on the representation acquired by the environment monitoring assembly and the direction detected by the passenger monitoring assembly.

15. The aircraft according to claim 10, wherein the information visualization assembly is adapted to visualize information on the screen with respect to objects to which the passenger is one of looking and pointing, respectively.

16. The aircraft according to claim 10, wherein the passenger monitoring assembly is adapted to track a direction in which the eyes of the passenger are directed.

17. The aircraft according to claim 10, wherein the screen comprises a pressure sensitive matrix layer providing 2D information on a location pressed by the passenger and wherein the passenger monitoring assembly is connected to the screen for receiving information from the pressure sensitive matrix layer.

18. The aircraft according to claim 10, wherein the screen may be switched to a transparent mode.

19. The aircraft according to claim 10, wherein the environment monitoring assembly comprises at least one camera.

20. The aircraft according to claim 10, further comprising an output assembly adapted for outputting information provided by the information visualization assembly to an external passenger end device.

21. The aircraft according to claim 20, wherein the output assembly is adapted to output information via at least one of WiFi, Bluetooth and Near-Field-Communication.
